(19) United States
(12) Patent Application Publication
(10) Pub. No.: US 2020/0257066 A1
(43) Pub. Date: Aug. 13, 2020

(54) OPTICAL INTERCONNECT TOPOLOGY

(71) Applicant: Hewlett Packard Enterprise Development LP, Houston, TX (US)

(72) Inventors: Mir Ashkan Seyedi, Palo Alto, CA (US); Frank R. Dropps, Annandale, MN (US)

(21) Appl. No.: 16/272,785

(22) Filed: Feb. 11, 2019

(51) Int. Cl. G02B 6/42; G02B 6/43; G02B 6/293

(52) U.S. Cl. CPC G02B 6/4215; G02B 6/43; G02B 6/29338; G02B 6/4286; G02B 6/29382; G02B 6/4249

(57) ABSTRACT

Examples herein relate to optical interconnect topologies. In particular, implementations herein relate to optical interconnects that include a transmitter. The transmitter includes an optical source configured to emit light, a waveguide coupled to the optical source and configured to receive the emitted light from the optical source, a plurality of ring resonators coupled to the waveguide, each ring modulator corresponding to a different channel of the optical source, and wherein each ring resonator is configured to be tuned to a single wavelength of the emitted light different from the other ring resonators. The transmitter further includes a plurality of optical couplers, each optical coupler coupled to a drop port of a respective ring resonator, and wherein each optical coupler is configured to be coupled to an optical fiber and to couple the single wavelength of the emitted light from each respective ring resonator to the optical fiber.

### STATEMENT OF GOVERNMENT RIGHTS

This invention was made with Government support under Agreement Number H98230-19-3-0002. The Government has certain rights in the invention.

### BACKGROUND

Optoelectronic communication (e.g., using optical signals to transmit electronic data) is becoming more prevalent as a potential solution, at least in part, to the ever increasing demand for high bandwidth, high quality, and low power consumption data transfer in applications such as high performance computing systems, large capacity data storage servers, and network devices. For certain workloads and computer network topologies, a high node count with an always on, all-to-all optical interconnect is highly desirable.

### BRIEF DESCRIPTION OF THE DRAWINGS

Certain examples are described in the following detailed description and in reference to the drawings, in which:

FIG. 1A schematically illustrates a block diagram of an example of a transmitter of an optical interconnect system according to the present disclosure;

FIG. 1B schematically illustrates a block diagram of an optical interconnect system including the transmitter of FIG. 1A according to the present disclosure;

FIGS. 2 schematically illustrates a block diagram of an example of an optical interconnect system including a plurality of transmitters and an optical shuffle according to the present disclosure;

FIG. 3A schematically illustrates a block diagram of another example of an optical interconnect system according to the present disclosure; and

FIG. 3B illustrates a close-up view of a fiber loop of the optical interconnect system of FIG. 3A.

### DETAILED DESCRIPTION OF SPECIFIC EXAMPLES

The present disclosure describes interconnects (e.g., interconnect topologies) that are scalable and advantageous for networks that require a large number of all-to-all or point-to-point links between one or more node or send/receive pairs. In particular, silicon photonics interconnects or topologies are provided herein that may achieve at least moderate bandwidth between many nodes with physical, optical fiber connections. In some implementations, the one or more node or send/receive pairs are coupled with an optical fiber allowing a single wavelength to pass therebetween. In other implementations, multiple wavelengths or groups of wavelengths may be transmitted or received by nodes while simultaneously passing multiple wavelengths or groups of wavelengths to other nodes via optical fiber loops connecting three or more nodes. In some implementations, such interconnects as described herein do not rely on or include one or more of the following: wavelength synchronization between transmit and receive pairs, arbitration of the fiber(s), demultiplexers on the receiver side, and/or an optical crossbar. In some implementations, the optical interconnects may be sized to fit a face-plate form factor or as a mid-board optical connector.

A “node” as described herein may refer to a network switch to which a plurality of computer processing units (CPUs), graphical processing units (GPUs), or memory media are connected in an arbitrary number. The network switch may communicate with other network switches of the same kind to which the same processor and memory units may be connected. However, in other implementations, “node” may also refer to a processor which may be responsible for communication with all other nodes in the network or subnetwork. An “optical fiber” as described herein can refer to a single optical fiber (e.g., including a core and a cladding) to provide unidirectional optical communication, can refer to a bidirectional pair of optical fibers (e.g., each including a core and a cladding) to provide both transmit and receive communications in an optical network, or can refer to a multi-core fiber, such that a single cladding could encapsulate a plurality of single-mode cores. Optical fibers can extend contiguously and uninterrupted between node or send/receive pairs (e.g., via pass-through connections) or include two or more fibers connected via fiber-to-fiber connections such that the fibers function or perform as a single fiber.

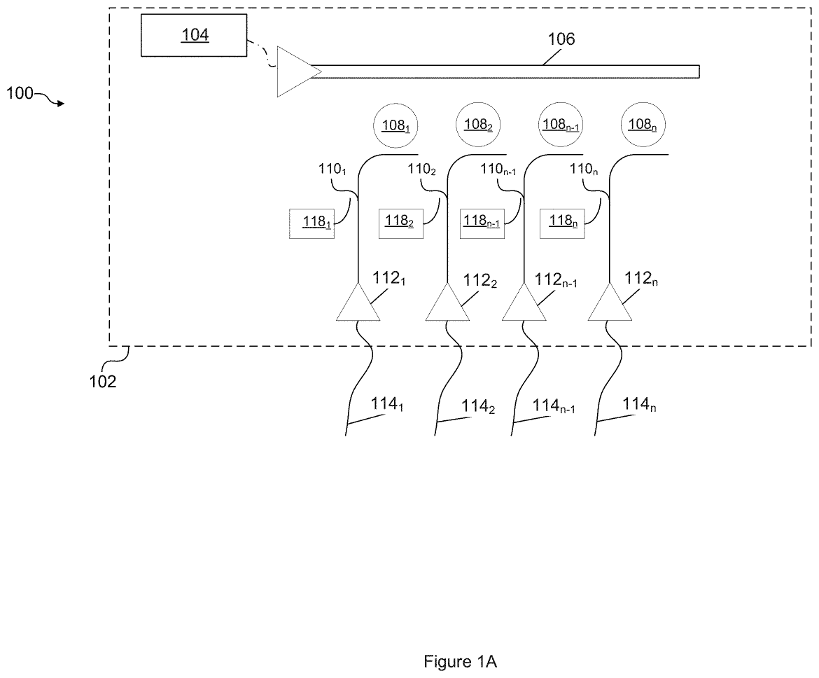

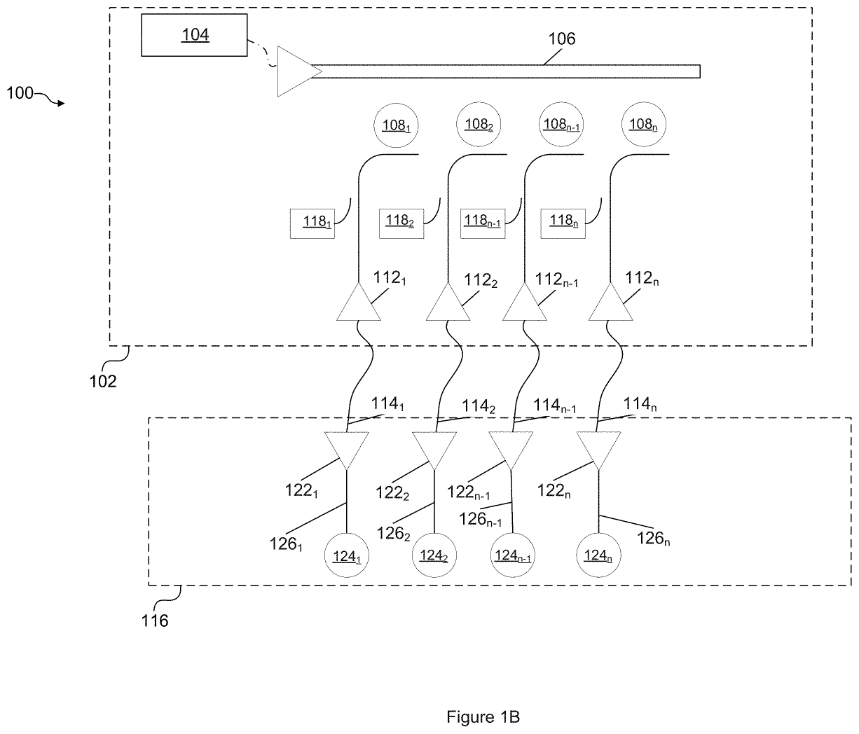

FIGS. 1A-1B illustrate an example of an optical interconnect system 100 and components thereof according to the present disclosure. The optical interconnect system 100 includes a transmitter or transmitter module 102. The transmitter includes at least one optical source 104. The optical source 104 may disposed be off-chip or on-chip of a silicon photonics interconnect. For example, the optical source 104 may be a comb laser configured to generate a plurality of different laser lines or wavelengths from a single module.

The transmitter 102 includes a waveguide 106 coupled to the optical source 104 and configured to receive the emitted light (e.g., multiple wavelengths of light) from the optical source 104. The waveguide 106 may be a multimode input bus waveguide. The transmitter 102 further includes a plurality of ring resonators 108 (identified individually as ring resonators 108₁ to 108ₙ) coupled to the waveguide 106. Each ring resonator 108 corresponds to a different channel or wavelength of the multiple wavelengths emitted from the optical source 104. The ring resonators 108 are each configured to be tuned to a single wavelength of the emitted light different from the other ring resonators 108. The number n of ring resonators determines the number of channels of the transmitter 102. For example, when n=8, there are 8 ring resonators 108 synchronized or tuned to 8 different wavelengths (e.g., within the spectrum of multiple wavelengths emitted from optical source 104 and through waveguide 106), thus forming an 8-channel transmitter 102. In some implementations, n can equal 4, 8, 16, 32, 64, 128, or any value therebetween.

The ring resonators 108 may be tuned to different resonant wavelengths and act as filters to drop the respective resonant wavelengths from the waveguide 106. For example, the ring resonators 108 are configured to demultiplex the light from the optical source 104. Resonant wavelengths specific or corresponding to each ring resonator 108 are individually demultiplexed into separate waveguides 110 (e.g., “drop or output waveguides” identified individually as waveguides 110₁ to 110ₙ).

Each of the ring resonators 108 includes a waveguide in a closed loop, coupled to the waveguides 106 and 110. When light of the appropriate wavelength is coupled from the waveguide 106 to a corresponding ring resonator 108, constructive interference causes a buildup in intensity over multiple round-trips through the ring resonator 108. The light is coupled to the respective output waveguide 110. Thus, the ring resonators 108 can “drop” or otherwise filter a single wavelength of light from the multi-wavelength, optical source 104 coupled to the waveguide 106 to respective waveguide 110. Reversing the input and output roles, allows the ring resonators 108 to function as a multiplexer to combine various optical signals from the waveguides 110 into the single waveguide 106.

Resonance properties of each ring resonator 108 can be precisely tuned to select the specific wavelength by varying the radius of each ring or by tuning the cladding index. Tuning may be accomplished via thermal tuning (e.g., providing a controllable micro-heater by each ring resonator 108), bias-tuning, or a combination of both.

The transmitter 102 can further includes a plurality of fiber-to-waveguide or optical couplers 112 (e.g., identified individually as optical couplers 112₁ to 112ₙ). Each optical coupler 112 is coupled to a drop port of a respective ring resonator 108 (e.g., via the waveguides 110). Each of the optical couplers 112 is configured to be coupled to an optical fiber 114 (e.g., identified individually as optical fibers 114₁ to 114ₙ) to couple the single wavelength of the emitted light from each respective ring resonator 108 to the respective optical fiber 114 as described in more detail below with respect to FIG. 1B. The optical couplers 112 can be coupled to an end of the optical fiber 114 via fiber connection solutions including fiber pigtail and lens to ferrule. An opposing end of each optical fiber 114 may then be coupled to a corresponding photodetector on the receiver 116 (see FIG. 1B). Therefore, the number n of optical couplers 112 determines the number of all-to-all, point-to-point, or directly connected nodes in a network topology (e.g., node pairs on the transmitter and receiver sides, respectively). The optical couplers as described herein may include, but are not limited to: grating couplers, prisms, collimating lenses, microrings, parabolic reflectors, spot-size converters, inversely tapered waveguides, or bent waveguides.

In some implementations, the transmitter 102 includes monitoring photodetectors 118 (e.g., identified individually as monitoring photodetectors 118 to 118n). The photodetectors 118 can be coupled to the ring resonators 108 or waveguides 110 to monitor operation of the optical source 104. For example, the monitoring detectors 118 can ensure the optical source 104 is functioning properly or is coupled correctly to each channel such that light is entering appropriately via the ring resonators 108.

As illustrated in FIG. 1B, opposing ends of each of the optical fibers 114 are coupled to an optical coupler 122 of the receiver 116 (e.g., identified individually as optical couplers 122₁ to 122ₙ). As described above, the optical couplers 122 can be coupled to respective optical fibers 114 via various fiber connection solutions generally known in the art. The optical couplers 122 are coupled to respective photodetectors 124 (e.g., identified individually as photodetectors 124₁ to 124ₙ) via waveguides 126 (e.g., identified individually as waveguides 126₁ to 126ₙ). The photodetectors 124 may convert the optical signals into electrical signals for further processing. Therefore, the optical fibers 114 provide physical, dedicated one-to-one links between node pairs on the transmitter 102 and receiver 116. As described above, single-wavelengths can be transmitted between the node pairs accordingly.

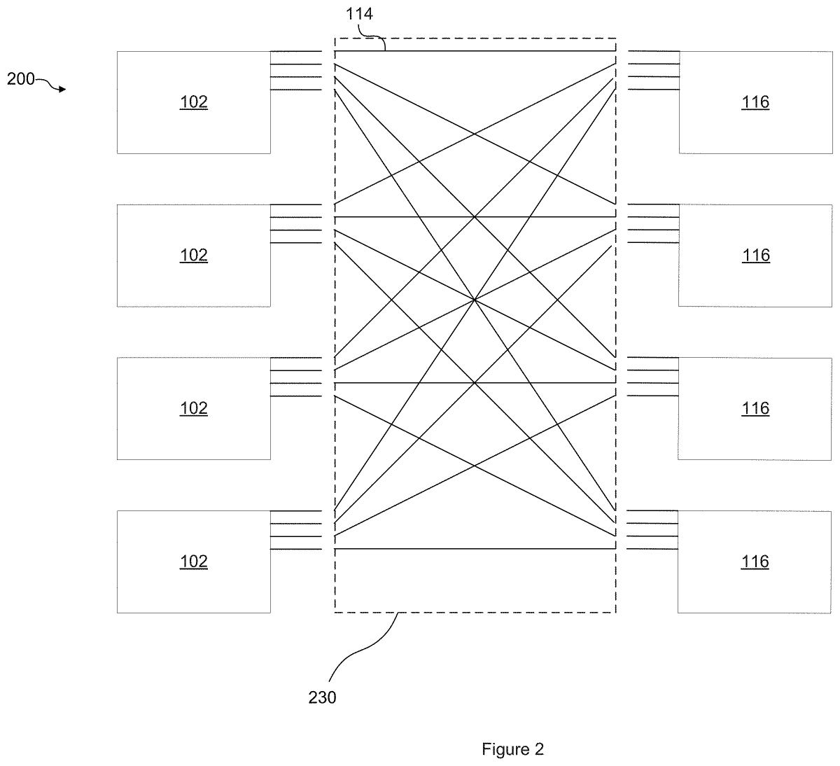

FIG. 2 illustrates an optical interconnect system 200. The optical interconnect system 200 can include any of the features as described above with respect to optical interconnect system 100, in whole or in part. For example, the optical interconnect system 200 includes a plurality of transmitters 102 and receivers 116. As described above, each of the transmitters 102 may include at least one optical source 104 to emit multi-wavelength light (e.g., four different single wavelengths each). The light may be spatially multiplexed (e.g., via multiple ring resonators 108) onto separate optical fibers 114 such that single wavelengths of light are transmitted therethrough. The optical fibers 114 are coupled to at least one of the transmitters 102 and receivers 116 to form a dedicated, physical link between the respective transmitter 102 and receiver 116 or node pair thereon. In some implementations, the optical interconnect system 200 can include an optical shuffle 230. The optical shuffle 230 can route optical fibers between the transmitters 102 and receiver 116. In some implementations, as illustrated, one optical fiber from each of the transmitters 102 is routed to each of the receivers 106. While the illustrated implementation includes four transmitters and four receivers with sixteen wavelengths therebetween, the system 200 is not limited thereto. For example, system 200 can include more than four transmitters and receivers or more than four wavelengths or channels each. For example, the transmitters and receivers may be configured with sixteen wavelengths or channels therebetween such that a total of 64 single wavelengths are transmitted/received.

Such a topology as described above with respect to FIGS. 1A-2 may be optimized or appropriate for network fabrics that require low latency and a moderate amount of bandwidth between nodes. For example, between 25 Gb/s and 100 Gb/s can be considered a moderate amount of bandwidth in some implementations. What is considered to be a moderate amount of bandwidth can be expected to increase over time. Because there is a dedicated, physical (e.g., optical fiber) connection between each node pair, automatic synchronization between the nodes is enabled and only spatial demultiplexing on the transmitter side is implemented. Single wavelengths are passed between the node pairs or transmitter and receiver via the optical fibers. This eliminates wavelength multiplexing on the transmitter side, complex arbitration schemes, and the requirement for demultiplexing on the receiver side or opposite node. This may lead to improvements in reducing power consumption, latency associated with wavelength synchronization, and thermal sensitivity relative to existing topologies as there is a direct, physical optical fiber connection between node pairs (e.g., on the receiver and transmitter sides). This allows for reduced complexity in both the transmitted and receive ends of the link. Further, the footprint of each grating is relatively small compared to a switch or processor chip (e.g., 10×10 micrometers). An interposer or substrate that holds the optical components can enable the optical components to be disposed directly underneath the electronics (e.g., a full 3D packaging scheme). Scalability is high as the number of ring resonators and interconnected nodes increases, the interposer or substrate will not increase in size substantially (e.g., relative to the processor chip or switch).

In some implementations, simultaneous transmission, receipt, or passing of one or more wavelengths (e.g., multiple or group of wavelengths) of light over one or more optical fiber loops in an all-to-all configuration are preferred or desired to achieve high bandwidth, and low latency. For example, this may include processor socket interconnects for processor messaging in non-uniform memory access (NUMA) multiprocessors, internet traffic, or other high bandwidth communications contexts. Typically, in a NUMA multiprocessor, multi-socket system, the system includes discrete processor sockets or processor chips and requires a high bandwidth connection between the processor sockets.

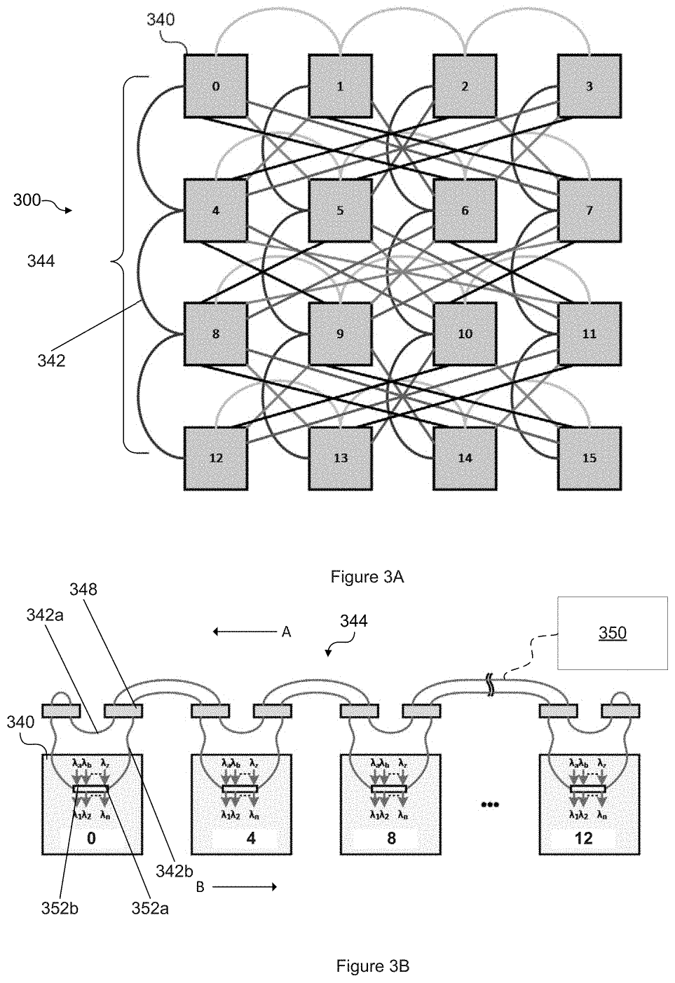

With reference to FIGS. 3A-3B, in some implementations, an optical interconnect system 300 is configured to allow multiple wavelengths to be transmitted/received and passed simultaneously between a plurality of node controllers 340 over one or more optical fiber loops 344. The optical fiber loops 344 include one or more optical fibers 342 coupling two or more node controllers 340 according to the present disclosure. In some implementations, the optical fiber loops 344 include one optical fiber allowing transmission or propagation of light in opposing directions (e.g., right and left or clockwise and counterclockwise). In other implementations (see FIG. 3B), the optical fiber loops 344 include two or more optical fibers. The first optical fiber allows transmission or propagation of light in a first direction and a second optical fiber allow transmission or propagation of the lights in a second direction opposite the first direction as described in more detail below. In some implementations, the optical fibers 342 are single optical fibers. In other implementations, the optical fibers 342 include a multi-fiber bundle for increased bandwidth (e.g., fibers are used in parallel to provide increased bandwidth).

Each node controller 340 is coupled to one or more processor sockets 346 (e.g., chips, nodes). In some implementations, the node controller 340 can be coupled to one, two, four, eight or more nodes of processor sockets 346. While illustrated as including sixteen node controllers 340 (identified numerically as 0 to 15), the optical interconnect system 300 can include more or less node controllers 340 (e.g., four, eight, thirty-two, sixty-four or more). The optical fiber loops 344 couple the node controllers 340 and corresponding processor sockets 346 in an all-to-all configuration or topology (e.g., in a loop or circle) such that any of the node controllers 340 or processor sockets 346 can communicate simultaneously with each other (e.g., simultaneously transmit/receive a first set of wavelengths and pass a second set of wavelengths different from the first set between or through any of the node controllers or processor sockets in any pattern or order).

As illustrated, different fiber optical loops 344 can couple different groups or sets of node controllers 340. The optical fiber loops 344 are therefore not considered “point-to-point” connections because the same fiber or fibers are shared between multiple node controllers 340 (e.g., node or send/receive pairs). However, the optical fiber loops 344 directly couple all the respective node controllers 340 “on” or coupled to the optical fiber loop 344. In this manner, all the node controllers 340 coupled to the optical fiber loop 344 can communicated simultaneously with each other in any order. As illustrated, in some implementations, groups or sets of four node controllers 340 can be coupled with one fiber optical loop 344. However, in other implementations, more or less node controllers 340 can be coupled together with one fiber optical loop 344 (e.g., three, five, six, seven, eight, or more). The number of node controllers 340 that can be coupled with the same fiber optical fiber loop 344 is dependent on the number of separate wavelengths available, the maximum band rate associated with each wavelength and the bandwidth that is required for a particular context or system.

In the illustrated implementation, there are 20 different optical fiber loops 344. For example, each optical fiber loop 344 couples a group, set, or combination of four node controllers 340 and each node controller 340 is coupled on five separate optical fiber loops 344. The groups of four node controllers 340 coupled to different optical fiber loops 344 such that all the node controllers 340 are coupled to each other are: (0,4,8,12), (1,5,9,13), (2,6,10,14), (3,7,11,15), (0,1,2,3), (4,5,6,7), (8,9,10,11), (12,13,14,15), (0,7,9,14), (0,6,11,13), (0,5,10,15), (1,6,8,15), (1,4,11,14), (1,7,10,12), (2,4,9,15), (2,5,11,12), (2,7,8,13), (3,4,10,13), (3,5,8,14), and (3,6,9,12)

With reference to FIG. 3B, a close-up view of a single optical fiber loop 344 of the optical interconnect system 300 of FIG. 3A is illustrated. For example, optical fiber loop 344 can be the optical fiber loop 344 coupling node controllers (0,4,8,12). Optical fiber loop 344 can include two multi-wavelength optical fibers 342 (e.g., identified individually as optical fiber 342a and 342b). The optical fibers 342 form the optical fiber loop 344 and are virtually or function as single optical fibers composed of optical fibers coupled via fiber-to-fiber connections 348 between each node controller 344 on the fiber optical loop 344. Further, each optical fiber loop 344 may be driven by an optical module 350 (e.g., a pluggable optical module) coupled to the optical fiber loop 344. The optical module 350 could be integrated into a package with the node controller or a network switching device.

The optical module 350 allows or is configured to allow simultaneous transmission and reception of multiple or a first set of wavelengths (e.g., 48 unique wavelengths) while passing, without modification, multiple or a second set of an additional group of unique wavelengths (e.g., 48) between any of the node controllers 344. The wavelengths that are used (e.g., dropped or taken off) by a specific node controller 340 and wavelengths that are passed through or bypassed to another node controller 340 on the same optical fiber loop 344 can be programmable or determinable in the optical module 350 based on device strapping or value of a programmable storage element. This allows selective coupling of data or wavelengths to the different node controllers 340 such that wavelengths to be taken off at a respective node controller and other wavelengths to be passed through are selectable.

In operation, data on the first set of wavelengths can be transmitted from and received by any of the node controllers 0, 4, 8, or 12 (e.g., along optical fiber loop 344). Simultaneously, the second set of wavelengths can pass through or bypass any of the node controllers 0, 4, 8, or 12 (e.g., along optical fiber loop 344). Any of the nodes (e.g., processor sockets or chips) coupled to the node controllers 340 or the node controllers 340 can communicate with each other simultaneously. The wavelengths can be transmitted and received and passed in any order or combination among the node controllers.

For example, as illustrated in FIG. 3B, each of the optical fibers 342a and 342b can be coupled to transmitters 352a and receivers 352b of the node controllers 340. Optical fiber 342a allows transmission or propagation of wavelengths in a first direction (e.g., identified by arrow A) and optical fiber 342b allows transmission or propagation of wavelengths in a second direction (e.g., identified by arrow B) opposite the first direction between the node controllers 0, 4, 8, or 12 along the optical fiber loop 344. In other implementations, the directions A and B can be switched.

In the illustrated implementation, this allows a first set of wavelengths (e.g., λₐ, λ_{b} . . . λλ_{z}) or a second set of wavelengths (e.g., λ₁, λ₂ . . . λₙ) to be transmitted from the transmitter 352a of node controller 0 to be received by receiver 352b of directly adjacent node controller 4 on the optical fiber loop 344 (e.g., along optical fiber 342b in the second direction) while simultaneously passing the other set of wavelengths from node controller 0 to be received by a receiver 352b of node controller 8 or node controller 12. The other set of wavelengths not received by the directly adjacent node controller 4 pass through (e.g., without being dropped or taken off by) node controller 4 or node controllers 4 and 8, respectively, depending on the receive destination (e.g., node controller 8 or 12).

Further, the first or second set of wavelengths may also be transmitted or passed along the optical fiber 342a in the first direction from one of the node controllers to another node controller on the optical fiber loop 344. For example, node controller 12 can transmit either set of wavelengths to node controller 0. In such a configuration, the wavelengths can be transmitted from node controller 12 along optical fiber 342b in the second direction and then loop back onto optical fiber 342a such that the wavelengths travel in the first direction to node controller 0 bypassing or skipping node controllers 4 and 8. Similarly, when node controller 4 or 8 are transmitting wavelengths with node controller 0 as the destination, the wavelengths first travel in the second direction until they loop back onto optical fiber 342a at node controller 12 to propagate in the opposite direction. In other implementations, the first or second set of wavelengths can be passed or transmitted from node controller 0 to node controller 12 or to node controller 8 via node controller 12 bypassing node controller 4 altogether (e.g., along optical fiber 342a when directions of the optical fibers 342a and 342b are switched). Providing the optical fiber loops described herein allow the first set of wavelengths (e.g., λₐ, λ_{b} . . . λ_{z}) to be transmitted to or received by any of the node controllers coupled to the optical fiber loop 344 while any of the node controllers simultaneously transmit the second set of wavelengths (e.g., λ₁, λ₂ . . . λₙ) to any of the node controllers or vice versa.

The optical fiber loops 344 can replace the requirement for an optical crossbar in such topologies and a selection of which fiber optical loop to use can be made within the ASIC of a respective node controller 340. There is no requirement for an optical crossbar or arbitration scheme as there are no conflicts between nodes or node controllers on an optical fiber loop as the optical fiber loops allow node controllers to simultaneously transmit or receive data on a set of optical wavelengths from all the other nodes or node controllers on the respective fiber loop.

In the foregoing description, numerous details are set forth to provide an understanding of the subject disclosed herein. However, implementations may be practiced without some or all of these details. Other implementations may include additions, modifications, or variations from the details discussed above. It is intended that the appended claims cover such modifications and variations. The specification and drawings are, accordingly, to be regarded as illustrative rather than restrictive.

It will be recognized that the terms “comprising,” “including,” and “having,” as used herein, are specifically intended to be read as open-ended terms of art. The term “or,” in reference to a list of two or more items, covers all of the following interpretations of the word: any of the items in the list, all of the items in the list, and any combination of the items in the list. As used herein, the terms “connected,” “coupled,” or any variant thereof means any connection or coupling, either direct or indirect (e.g., having additional intervening components or elements), between two or more elements, nodes, or components; the coupling or connection between the elements can be physical, mechanical, logical, optical, electrical, or a combination thereof.

In the Figures, identical reference numbers identify identical, or at least generally similar, elements. To facilitate the discussion of any particular element, the most significant digit or digits of any reference number refers to the

Figure in which that element is first introduced. For example, element 110 is first introduced and discussed with reference to FIG. 1.

1. An optical interconnect comprising:
a transmitter comprising;
a optical source configured to emit light;
a waveguide coupled to the optical source and configured to receive the emitted light from the optical source;
a plurality of ring resonators coupled to the waveguide, each ring resonator of the plurality of ring resonators corresponding to a different channel of the optical source, and wherein each ring resonator is configured to be tuned to a single wavelength of the emitted light different from the other ring resonators of the plurality of ring resonators;
a plurality of optical couplers, each optical coupler of the plurality of optical couplers coupled to a drop port of a respective ring resonator of the plurality of ring resonators; and
a plurality of optical fibers, each optical fiber having first and second opposing ends, wherein each optical coupler is configured to be coupled to the first end of a respective optical fiber of the plurality of optical fibers to couple the single wavelength of the emitted light from each respective ring resonator to the respective optical fiber such that respective wavelengths of the emitted light are spatially demultiplexed onto the respective optical fibers from each respective ring resonator without wavelength multiplexing any wavelengths of the emitted light from the optical source at the transmitter.

2. (canceled)

3. The optical interconnect of claim 1, further comprising a receiver, the receiver comprising a plurality of photodetectors and wherein the second end of each respective optical fiber is coupled to the receiver such that a physical, optical fiber connection is provided between each respective ring resonator of the transmitter and each respective photodetector of the receiver for each channel of the optical source.

4. The optical interconnect of claim 1, further comprising an optical shuffle configured to route the plurality of optical fibers between the transmitter and the receiver.

5. The optical interconnect of claim 1, wherein the optical source comprises an on- or off-chip multi-wavelength comb laser.

6. The optical interconnect of claim 1, wherein the optical source comprises an array of quantum dot light-emitting diodes.

7. The optical interconnect of claim 1, wherein the plurality of ring resonators are tuned via at least bias tuning, thermal tuning, or both.

8. The optical interconnect of claim 1, wherein the transmitter further comprises a plurality of monitoring photodetectors, each monitoring photodetector of the plurality of monitoring photodetectors coupled to a different ring resonator and configured to monitor the light transmitted therethrough.

9. An optical interconnect system comprising:
a plurality of receivers, wherein each receiver of the plurality of receivers comprises a plurality of photodetectors;
a plurality of transmitters, wherein each transmitter of the plurality of transmitters comprises;
an optical source configured to emit light;
a waveguide coupled to the optical source and configured to receive the emitted light from the optical source;
a plurality of ring resonators coupled to waveguide, each ring resonator of the plurality of ring resonators corresponding to a different channel of the optical source, and wherein each ring resonator is configured to be tuned to a single wavelength of the emitted light different from the other ring resonators of he plurality of ring resonators;
a plurality of optical couplers, each optical coupler of the plurality of optical couplers coupled to a drop port of a respective ring resonator of the plurality of ring resonators; and
a plurality of optical fibers coupling the plurality of receivers and transmitters, wherein each optical coupler is coupled to a respective optical fiber of the plurality of optical fibers and is configured to couple the single wavelength of the emitted light from each respective ring resonator to the optical fiber such that respective wavelengths of the emitted light are spatially demultiplexed onto the respective optical fibers from each respective ring resonator without wavelength multiplexing any wavelengths of the emitted light from the optical source at the transmitter.

10. The optical interconnect system of claim 9, further comprising an optical shuffle configured to route the plurality of optical fibers between the transmitters and the receivers such that a first optical fiber of a first transmitter is routed to a first receiver and a second optical fiber of the first transmitter is routed to a second receiver different from the first receiver.

11. The optical interconnect system of claim 9, wherein each transmitter of the plurality of transmitters further comprises a plurality of monitoring photodetectors, each monitoring photodetector of the plurality of monitoring photodetectors coupled to a different ring resonator and configured to monitor the light transmitted thereto.

12. The optical interconnect system of claim 9, wherein the plurality of ring resonators are tuned via at least bias tuning, thermal tuning, or both.

13. An optical interconnect system to connect processor sockets, the optical interconnect system comprising:
a plurality of node controllers, wherein each of the node controllers is coupled to one or more processor sockets;
a plurality of optical fiber loops coupling the one or more processor sockets of each node controller in an all-to-all topology such that each node controller is coupled to the other node controllers via at least one of the optical fiber loops of the plurality of optical fiber loops, the optical fiber loops configured to allow simultaneous transmission or reception of a first set of optical wavelengths between a first node controller and a second node controller while passing a second set of optical wavelengths different from the first set of optical wavelengths from the first node controller to a third node controller.

14. The optical interconnect system of claim 13, wherein each of the optical fiber loops comprises one or more single fiber optical cables extending between the respectively coupled node controllers.

15. The optical interconnect system of claim 13, wherein a first optical fiber loop couples the first, second, and third node controllers.

16. The optical interconnect system of claim 15, wherein the second node controller is disposed between the first and third node controllers on the first optical fiber loop.

17. The optical interconnect system of claim 16, wherein the first set of wavelengths is transmitted from the first node controller to the second node controller and the second set of wavelengths is passed simultaneously from the first node controller to the third node controller bypassing the second node controller.

18. The optical interconnect system of claim 13, wherein a first set of node controllers is coupled to a second set of node controllers via a first optical fiber loop and the first set of node controllers is coupled to a third set of node controllers via a second optical fiber loop different from the first optical fiber loop.

19. The optical interconnect system of claim 13, wherein each of the node controllers is coupled to two, four, or eight processor sockets.

20. The optical interconnect system of claim 13, wherein the optical interconnect system does not include an optical crossbar.
